(19) United States
(12) Patent Application Publication
(10) Pub. No.: US 2018/0265159 A1
(43) Pub. Date: Sep. 20, 2018

(54) SELF-BALANCING POWERED UNICYCLE DEVICE

(71) Applicant: Timur Artemev, Haslemere, Surrey (GB)

(72) Inventor: Timur Artemev, Haslemere, Surrey (GB)

(21) Appl. No.: 15/529,276

(22) PCT Filed: Feb. 2, 2015
(86) PCT No.: PCT/GB2015/050269

§ 371 Date: May 24, 2017

(30) Foreign Application Priority Data
Nov. 24, 2014 (GB) 1420845.8

(51) Int. Cl. B62K 11/00; B62K 1/00

(52) U.S. Cl. CPC B62K 11/007; B60L 11/1879; B62K 1/00

(57) ABSTRACT

A self-balancing powered unicycle is disclosed. The unicycle comprises: a single wheel; a motor adapted to drive the wheel; a balance control system adapted to maintain fore-aft balance of the unicycle device; a foot platform for supporting a user of the unicycle device, wherein the foot platform is movable between a stowed position and an active position; and an actuator coupled to the foot platform and adapted to move the foot platform between the stowed position and active position. The actuator comprises: a guide member; and a connecting element connected to the foot platform and slidably coupled to the guide member at a coupling position such that the coupling position moves relative to the guide member as the foot platform is moved between the stowed position and active position.

### FIELD OF INVENTION

The present invention relates to powered single-wheeled devices and more particularly to powered unicycles with self-balancing functionality.

### BACKGROUND TO THE INVENTION

Powered self-balancing vehicles for use while standing are known. Such vehicles include two-wheeled vehicles and single-wheeled vehicles (i.e. unicycles).

In a powered self-balancing unicycle, an electronic or mechanical system that controls the wheel in the appropriate direction is typically used to achieve fore-and-aft balance. This type of automatic fore-and-aft balance technology is well known and described, for example, in U.S. Pat. No. 6,302,230. A sensor and electronic equipment are typically provided. Information detected by the sensor and the electronics is relayed to a motor. The motor drives the wheel in the appropriate direction and at sufficient speed to maintain fore-and-aft balance.

Known embodiments of a powered self-balancing unicycle do not include a handle bar supported by a shaft. For example, U.S. patent application Ser. No. 12/281,101 presents a single wheel, coupled to a frame to which two platforms (one on each side of the wheel) are attached.

### SUMMARY OF THE INVENTION

According to a first aspect of the invention, there is provided a self-balancing powered unicycle device, comprising: a single wheel; a motor adapted to drive the wheel; a balance control system adapted to maintain fore-aft balance of the unicycle device; a foot platform for supporting a user of the unicycle device, wherein the foot platform is movable between a stowed position and an active position; and an actuator coupled to the foot platform and adapted to move the foot platform between the stowed position and active position, wherein the actuator comprises: a guide member; and a connecting element connected to the foot platform and slidably coupled to the guide member at a coupling position such that the coupling position moves relative to the guide member as the foot platform is moved between the stowed position and active position.

There is proposed a self-balancing powered unicycle comprising an actuator that is adapted to move a foot platform of the unicycle between the stowed position and active position. Embodiments therefore provide an arrangement for moving a foot platform of a self-balancing powered unicycle between two positions or configurations.

Embodiments may employ an actuator connected to the foot platform and slidably coupled to the guide member. This may help to reduce the size (e.g. thickness, length or vertical profile) of the actuator when the foot support is in either configuration, thereby allowing the unicycle device to have a slim body. In other words, embodiments may employ an actuator which helps to reduce the size and/or width of the unicycle device.

The actuator arrangement according to an embodiment may help to ensure that sufficient leverage can be generated to the move the foot platform, while maintaining a slim-line design to ensure the unicycle can meet predetermined size, weight, height or volume requirements.

The connecting element may, for example, be coupled to a bridging bar that is pivotally coupled to the foot platform. Embodiments may therefore employ a simple and cheap mechanical arrangement that can be driven so as to move the foot platform between predefined configurations.

The foot platform may comprise left and right foot supporting sections situated on opposite sides of the wheel. Also, the left foot supporting section may be pivotally coupled to one end of the bridging bar and the right foot supporting section may be pivotally coupled to the other end of the bridging bar. Embodiments may therefore be adapted to cater for various configurations of foot platforms, such as: single foot platforms that extend through the unicycle device so as to protrude from either side; or separate foot platforms (provided for each foot of a user) situated on opposite sides of the unicycle device. Further, where two (e.g. left and right) foot platforms are employed, operation of a single actuator according to an embodiment may move both of the foot platforms, thus avoiding the need for repeated and/or complicated actuator arrangements.

In an embodiment, the actuator may be adapted to affect sliding of the coupling position relative to the guide member so as to move the connecting element. Further, the actuator may further comprise: one or more hydraulic, electric or mechanical actuators adapted to slidably move the coupling position.

The connecting element may comprise a lever pivotally connected to the foot platform and slidably coupled to the guide member at a coupling position. Further, the lever may comprise a rigid bar of fixed length. Also, the actuator may be adapted to affect sliding of the coupling position relative to the guide member so as to pivotally move the lever. Embodiments may therefore employ a simple and cheap mechanical arrangement that can be driven so as to move the foot platform between predefined configurations.

In an embodiment, the guide member may comprise a threaded section, and the connecting element may be threadably engaged with threaded section of the guide member at the coupling position. Further the actuator may comprise an electric motor adapted to cause rotation of the threaded section relative to the connecting element so as to slidably move the coupling position and thereby cause movement of the foot platform between the stowed position and active position. Thus, an embodiment may employ a motor to drive movement of the connecting element which, in turn, causes the foot platform to move between the stowed position and active position. The motor may be controlled so that movement of the foot platform activated and/or prevented according to predetermined conditions.

The unicycle device may further comprise: an entity presence detection system adapted to detect the presence of an entity on, at or near a part of, the powered unicycle and provide an indication of detected entity presence; and a control system adapted to control operation of the actuator based on the indication of detected entity presence from the entity presence detection system. Thus, an embodiment may provide an indication or signal which is used by a control system to alter operation of the actuator upon occurrence of one or more predetermined conditions indicating an entity (such as a user) is present or not-present on the unicycle. Such embodiments may therefore enable quick and easy deployment from an off configuration (wherein the foot platform is in a stowed position, for example) to an on configuration (wherein the foot platform is in an active position, for example). This deployment may require little or no input from the user, but instead may be automatically achieved when the user is in close proximity with, or contacts) one or more predetermined parts of the unicycle.

Embodiments may enable the foot platform to automatically move to a stowed configuration if the user alights or dismounts from the unicycle (e.g. by intentionally stepping off the foot platform(s) or by falling off). Embodiments may therefore facilitate multiple functions, including the provision of an automatic foot platform deployment mode, the provision of quick start-up/deployment, and the provision of an automatic-stowing safety feature. Embodiments may thus provide not only for improved user interaction, but also for improved safety and to protect the unicycle or its user.

According to another embodiment, the entity presence detection system may comprise a load sensing system adapted to determine a loading applied to at least one part of the powered unicycle. Further, the load sensing system may be adapted to determine at least one of: a deflection of the wheel axel; a compressive force applied to the wheel axel; a deflection of the at least one foot platform; a tensile force applied to the at least one foot platform; and a compressive force applied to the at least one foot platform, so as determine a loading applied to the at least one foot platform of the powered unicycle. In such embodiments, operation of the actuator may be based on a value of the loading applied to one or more of its parts. In some embodiments, the entity presence detection system may comprise a processing unit adapted to process signals in accordance with an algorithm to determine if an entity is present on, at or near a part of the powered unicycle. By way of example, such an algorithm may be adapted to determine if the signals from the drive arrangement and/or the balance control system exhibit a predetermined characteristic indicating the presence or non-presence of a user on the powered unicycle. The signals from the drive arrangement and/or the balance control system may comprise information relating to at least one of: casing orientation; inclination or angle of a part of the unicycle; value of compressive force applied to at least part of a foot platform; accelerometer data; gyroscope data; motor torque; speed of wheel rotation; and a motor drive voltage.

According to yet another embodiment, the entity presence detection system may comprise a vibration sensor adapted to detect a frequency of vibration of at least one part of the powered unicycle. The entity presence detection system may be adapted to determine the presence or non-presence of a user based on if a detected frequency of vibration of at least one part of the powered unicycle is within a predetermined range.

In another embodiment, the connecting element may be slidably coupled to the guide member via a slide mechanism, the slide mechanism comprising: a track provided on the guide member; and a follower provided on the connecting element to move along the track as the foot platform is moved between the stowed position and active position. Also, the follower may comprise at least one wheel pivotally connected to the connecting element.

For the avoidance of doubt, reference to a single wheel should be taken to mean the generally circular unit that is positioned between the legs of a user and adapted to rotate about an axis to propel the unicycle in a direction during use. The single wheel may therefore be formed from one or more tyres and/or hubs that are coupled together (via a differential, for example). For example, an embodiment may comprise a single hubless wheel having a single hubless rim with a plurality of separate tyres fitted thereon. Alternatively, an embodiment may comprise a single hubless wheel formed from a plurality of hubless rims (each having a respective tyre fitted thereon), wherein the plurality of hubless rims are coupled together via a differential bearing arrangement.

Embodiments may provide a self-balancing powered unicycle that can alter the configuration of its foot platform(s), and such alteration may be driven by drive means (such as a motor) rather than being undertaken manually. For example, the actuator may be automatically enabled or disabled to facilitate rapid and simple operation of the unicycle.

According to another aspect of the invention, there is provided an actuator for a self-balancing powered unicycle device having a foot platform for supporting a user of the unicycle device, the foot platform being movable between a stowed position and an active position, the actuator being adapted to move the foot platform between the stowed position and active position, and wherein the actuator comprises: a guide member; and a connecting element adapted to be connected to the foot platform and slidably coupled to the guide member at a coupling position such that the coupling position moves relative to the guide member as the foot platform is moved between the stowed position and active position.

### BRIEF DESCRIPTION OF THE DRAWINGS

An example of the invention will now be described with reference to the accompanying diagrams, in which:

FIG. 1 is an isometric view of an embodiment of a powered unicycle device in a closed configuration;

FIG. 2 is an exploded diagram of components internal to the casing of FIG. 1,

FIGS. 3A & 3B are side and front elevations, respectively, of the embodiment of FIG. 1, wherein the casing is moving between a closed and open configuration;

FIGS. 4A & 4B are side and front elevations, respectively, of the embodiment of FIG. 1, wherein the casing is in an open configuration and the foot platforms are in a stowed configuration;

FIG. 5 is an isometric view of the embodiment of FIG. 1, wherein the casing is in an open configuration and the foot platforms are in a stowed configuration;

FIGS. 6A & 6B are side and front elevations, respectively, of the embodiment of FIG. 1, wherein the casing is in an open configuration and the foot platforms are in an active configuration;

FIG. 7 is an isometric view of the embodiment of FIG. 1, wherein the casing is in an open configuration and the foot platforms are in an active configuration;

FIG. 8 shows an actuator according to an embodiment employed in a self-balancing powered unicycle, wherein only the drive wheels and foot platforms are depicted, and wherein the foot platforms are in an active configuration;

FIG. 9 shows the embodiment of FIG. 8, wherein the actuator is moving the foot platforms from an active configuration towards a stowed configuration;

FIG. 10 shows the embodiment of FIG. 8, wherein the actuator has moved the foot platforms to a stowed configuration;

FIG. 11 shows an actuator according to another embodiment employed in a self-balancing powered unicycle, wherein only the drive wheels and foot platforms are depicted, and wherein the foot platforms are in an active configuration; and

FIG. 12 shows the embodiment of FIG. 8, wherein the actuator has moved the foot platforms towards a stowed configuration.

### DETAILED DESCRIPTION

Proposed is self-balancing powered unicycle device having an actuator which is adapted to slide with respect to a support as it moves a foot platform of the unicycle device between a stowed configuration and an active configuration. The actuator arrangement has a small vertical thickness (or profile) when the foot platform is the active configuration, thereby enabling the unicycle device to have a reduced size. In other words, embodiments may employ an actuator which helps to reduce the size and/or width of the unicycle device.

The term vertical, as used herein, means substantially orthogonal to the surface of a substrate. The term lateral, as used herein, means substantially parallel to the surface of a substrate. Also, terms describing positioning or location (such as above, below, top, bottom, etc.) are to be construed in conjunction with the orientation of the structures illustrated in the diagrams.

The diagrams are purely schematic and it should therefore be understood that the dimensions of features are not drawn to scale. Accordingly, the illustrated thickness of any of the components or features should not be taken as limiting. For example, a first component drawn as being thicker than a second component may, in practice, be thinner than the second component.

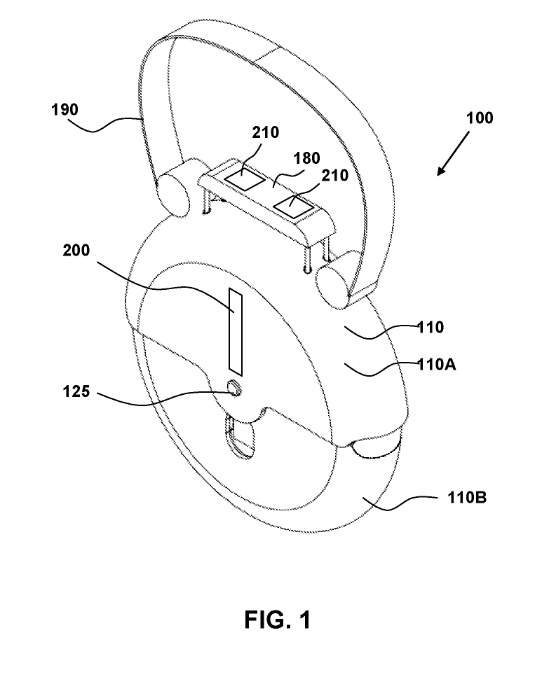

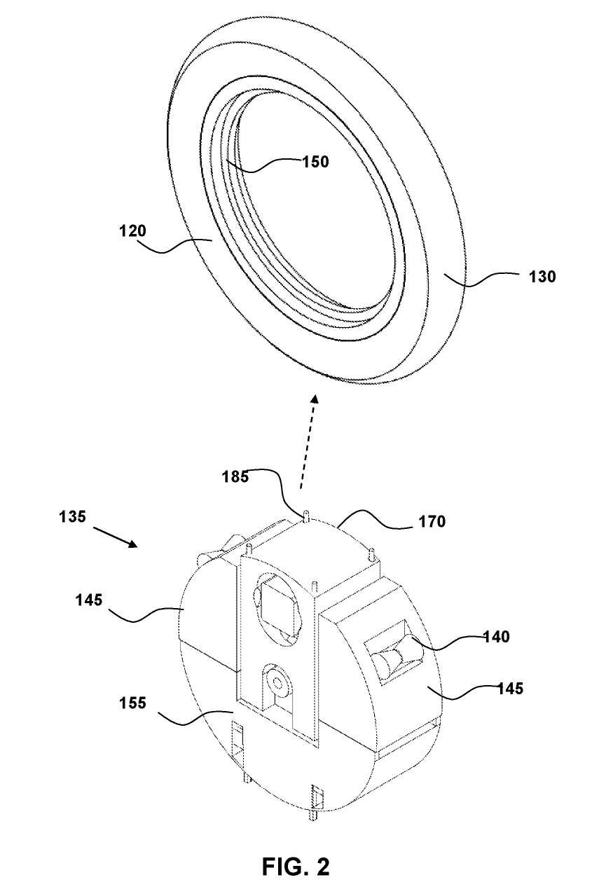

FIGS. 1-7 show one embodiment of a powered unicycle device 100. FIG. 1 shows the powered unicycle device 100 with a casing 110 in a closed configuration so that it encases a single wheel 120. Here, the casing 110 is formed from a first, upper portion 110A that covers the top (uppermost) half of the wheel 120, and a second, lower portion 110B that covers the bottom (lowermost) half of the wheel 120. FIG. 2 illustrates an exploded view of components internal to the casing 110, namely a wheel 120 and drive arrangement 135.

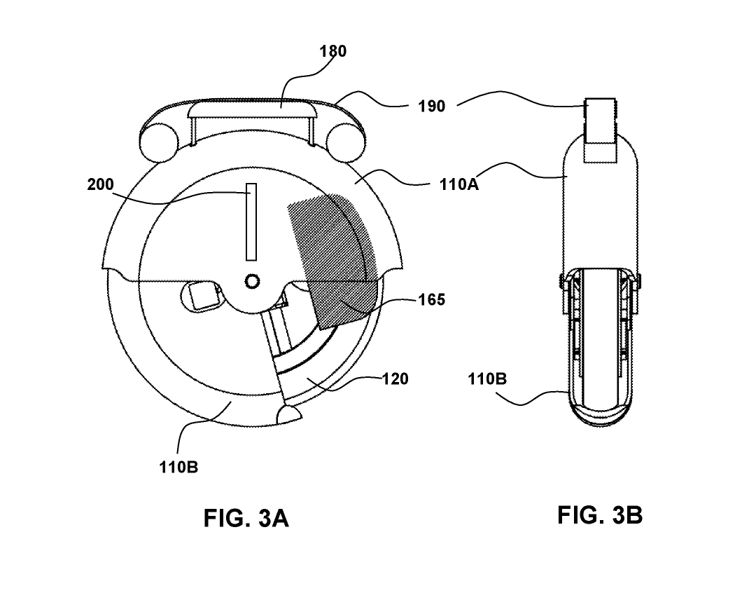

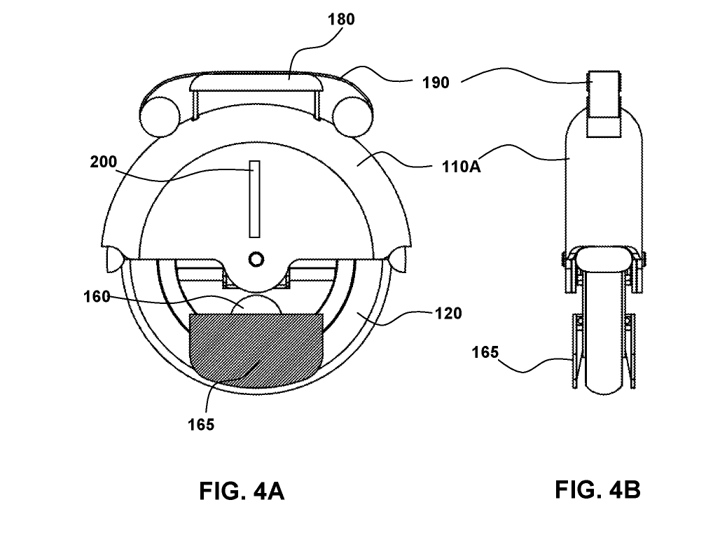

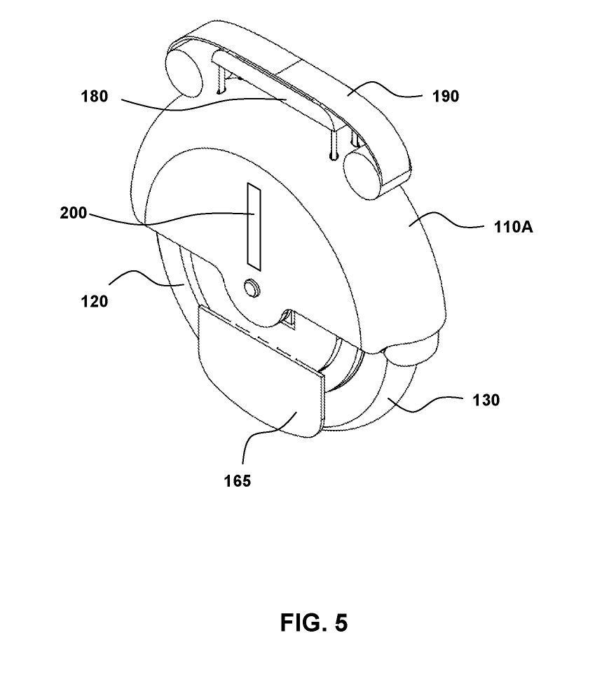

Referring back to FIG. 1, the wheel 120 spins about a central axis 125. The first, upper portion 110A of the casing is retained in a fixed position relative to the central axis 125, whereas the second, lower portion 110B of the casing is adapted to rotate about the central axis 125. Rotation of the second lower portion 1106 about the central axis 125 moves the casing between closed and open configurations (as illustrated by FIGS. 3-4). In the closed configuration (shown in FIG.1), the casing 110 encloses the wheel 120 so that the outer rim 130 of the wheel 120 is not exposed. In the open configuration (shown in FIG. 5), the outer rim 130 of the wheel 120 is exposed so that it can contact a ground surface.

Referring now to FIG. 2, rotation of the single wheel 120 is driven by a drive arrangement 135 according to an embodiment. The drive arrangement 135 includes guide wheels 140 attached to an outwardly facing side of respective batteries 145. In this embodiment, there are two pairs of angled guide wheels 140, wherein the two guide wheels in each pair share are tapered or conical such that they have a sloped surface which is not perpendicular to the radial plane of the single wheel 120. Put another way, the contact surface of each guide wheel is inclined with respect to the radial plane of the single wheel 120. The guide wheels 140 of each pair are also positioned spaced apart to provide a gap between the two guide wheels of a pair.

A rib 150 is provided around the inner rim of the wheel 120 and fits into the gap between the two guide wheels 140 in each pair. The guide wheels 140 are therefore adapted to contact with the inner rim of wheel 120 where they spin along with wheel 120 and hold wheel 120 in place by way of the rib 150. Of course, it will be appreciated that other arrangements, including those with only one guide wheel per battery 145, are possible.

The batteries 145 are mounted on a motor 155 which drives a pair of drive wheels 160 positioned at the lowermost point along the inner rim of the wheel 120. The batteries 145 supply power to motor 155 and, this embodiment, there are two batteries in order to create a balanced distribution of volume and weight. However, it is not necessary to employ two batteries 145. Also, alternative energy storage arrangements may be used, such as a flywheel, capacitors, and other known power storage devices, for example.

The drive arrangement 135 is adapted to be fitted inside the wheel. In other words, the drive arrangement is sized and shaped so that it can be positioned in the void define by the inner rim of the wheel 120. Further, the drive arrangement 135 is movable between a locked configuration and an unlocked configuration.

In the locked configuration, when fitted inside the wheel 120, the drive arrangement 135 engages with the rim of the wheel 120 to prevent its removal from the wheel. Here, in the embodiment shown, the guide wheels 140 contact the inner rim of wheel 120 and hold wheel 120 in place by way of the rib 150 when the drive arrangement is in the locked configuration.

In the unlocked configuration, when fitted inside the wheel 120, the drive arrangement 135 disengages with the rim of the wheel 120 to permit its removal from the wheel. Here, in the embodiment shown, the drive arrangement contracts in size when moved from the locked configuration to the unlocked configuration so that the guide wheels 140 no longer contact the inner rim of wheel 120 and no longer hold the wheel 120 in place by way of the rib 150. Such reduced size (e.g. diameter) of the drive arrangement 135 when in the unlocked configuration thus enables the drive arrangement 135 to be removed from the wheel 120.

It will therefore be understood that the drive arrangement 135 of the illustrated embodiment can be quickly and easily connected or removed to/from the wheel 120 for repair or replacement, for example. Arranging the drive arrangement 135 in the unlocked configuration permits its removal or fitting from/to the wheel 120 (because, for example, its dimensions when in the unlocked configuration permit its fitting inside the wheel). When fitted inside the wheel 120, the drive arrangement can be arranged in the locked configuration so that it engages with the rim of the wheel 120 to prevent its removal (because, for example, its dimensions when in the locked configuration prevent the drive arrangement from being removed from the wheel).

When the drive arrangement 135 is fitted inside the wheel and in the locked configuration, a pair of drive wheels (not visible in FIG. 2) is adapted to contact the inner rim of the wheel 120. Here, the pair of drive wheels comprises first and second rollers that are inclined with respect to the radial plane of the wheel. By way of contact with the inner rim of the wheel 120, the drive wheels transmit torque from the motor 155 to the wheel 120. It will be understood that this drive system operates by friction and it may be preferable to avoid slippage between the drive wheels and the inner rim of wheel 120. Positioning the drive wheels at the lowermost point enables the weight of a user to provide a force which presses the drive wheels against the inner rim of the wheel 120, thereby helping to reduce or avoid slippage.

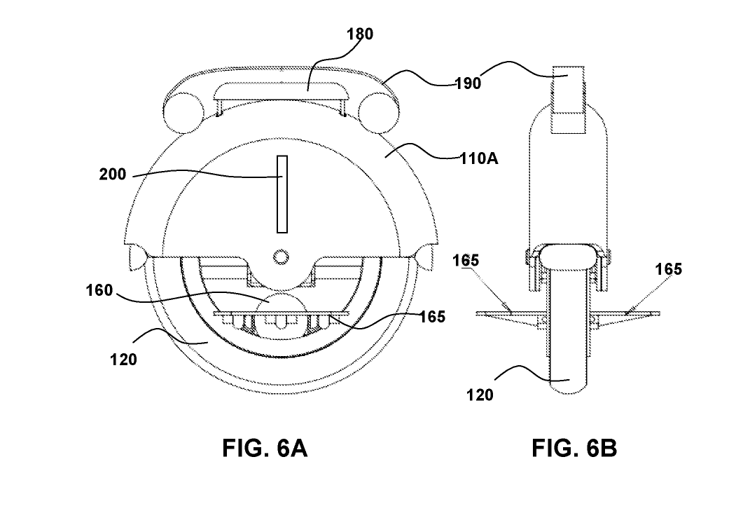

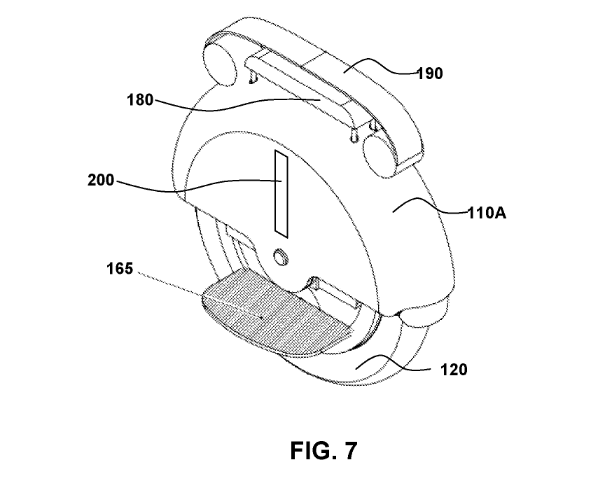

Referring to FIGS. 5-7, two foot platforms 165 are coupled to the second, lower portion 110B of the casing 110, with one on each side of wheel 120. In the open configuration, the foot platforms 165 are movable between a stowed configuration, wherein the foot platforms are substantially parallel with the plane of the wheel (as shown in FIG. 5), and an active configuration, wherein the foot platforms are substantially perpendicular to the plane of the wheel (as shown in FIGS. 6-7) so as to support a user's weight. Thus, in this embodiment, the foot platforms 165 are movable between: (i) a stowed configuration wherein they are flat against the side of the wheel and can be rotated (with the second, lower portion 110B of the casing) about the central axis 125 so as to be positioned inside (and covered by) the first, upper portion 110A of the casing; and (ii) an active configuration, wherein. Accordingly, the foot platforms 165 are upwardly foldable into a stowed configuration that narrows the profile of the unicycle 100 to aid in storage and carrying. In use, the foot platforms are moved to the active configuration, and the user stands with one foot on each platform 165.

The drive arrangement 135 includes a gyroscope or accelerometer system 170 which senses forward and backward tilt of the device in relation to the ground surface and regulates the motor 155 accordingly to keep the device upright. In this way, the user is provided a way of controlling the acceleration and deceleration of the unicycle by varying the pressure applied to various areas of the foot platforms 165. It also enables the unicycle to self-regulate its balance in the fore-and-aft plane.

When not in use, the foot platforms 165 are moved to the stowed configuration and then rotated (with the second, lower portion 1106 of the casing) about the central axis 125 so as to move the casing to the closed configuration. Thus, in the closed configuration, the foot platforms 165 are stored inside the casing (covered by the first, upper portion 110A of the casing).

The embodiment of FIGS. 1-7 also comprises a lifting handle 180 coupled to the drive arrangement 135 via a plurality of rods 185. The lifting handle 180 is positioned at the top of the casing 110, above the wheel 120, and may be used to hold the unicycle 100 above the ground, for example to enable a user to lift, carry, convey or place the unicycle 100.

A retractable carrying strap 190 is also provided and attached to the top of the casing 100. The carrying strap 190 may be used to carry the unicycle 100, for example over the shoulder of user. A hook may be provided on the bottom of the case to create rucksack-like belts from the carrying strap 190.

The embodiment of FIGS. 1-7 further comprises an actuator (not visible in FIGS. 1-7) coupled to the foot platforms 165 and adapted to move the foot platforms between the stowed configuration and active configuration. The actuator comprises: a guide member (not visible in FIGS. 1-7); and a lever (not visible in FIGS. 1-7) pivotally connected to the foot platforms and slidably coupled to the guide member at a coupling position such that the coupling position moves relative to the guide member as the foot platforms are moved between the stowed configuration and active configuration.

Here, the actuator may affect sliding of the coupling position relative to the guide member so as to pivotally move the lever and thus move the foot platforms between the stowed configuration and active configuration. To affect such sliding of the coupling position, the actuator comprises an electric actuator, such as a motor, which is adapted to drive movement of the coupling position when activated. Of course, it will be understood that the actuator may employ other types of actuators to slidably move the coupling position, such as one or more appropriately arranged hydraulic, electric or mechanical actuators.

The embodiment of FIGS. 1-7 also comprises an entity presence detection system 200 adapted to detect the presence of a user. More specifically, in this embodiment, the entity presence detection system 200 comprise a proximity sensor 200 situated on each side of the first, upper portion 110A of the casing above the central axis 125. Each proximity sensor 200 is adapted to detect the existence of a user's leg in close proximity with the proximity sensor 200. In order to do this, the proximity sensors 200 may, for example, employ infrared reflection, ultrasonic sensing, and/or and light detection principles to detect if/when a user's leg is positioned in close proximity with the proximity sensor (e.g. contacting the first, upper portion 110A of the casing).

The proximity sensors 200 provide a signal indicating whether or not a user's presence it detected. This signal is provided to a control system (not shown) which is to control operation of the powered unicycle, by controlling the drive arrangement 135 for example. Based on an indication of detected user presence provided by the signal(s) from the proximity sensors 200, the control system controls operation of the powered unicycle.

Here, the entity presence detection system 200 is also adapted to trigger an activating system which moves the casing between the closed and open configurations. More specifically, the entity presence detection system 200 further comprises proximity sensors 210 incorporated into the handle 180 which are adapted to detect when a user's hand contacts the upper surface of the handle (e.g. when a user grips the handle 180). When one of the proximity sensors 210 incorporated into the handle 180 detects a user's hand contacting the upper surface of the handle 180, it provides an activation signal which triggers the activating system which, in turn, causes the second, lower portion 110B of the casing to rotate about the central axis to move from the closed configuration to the open configuration. This process of rotating the second, lower portion 11013 of the casing from the closed configuration to the open configuration is depicted by FIGS. 3-4.

Furthermore, the entity presence detection system 200 is also adapted to trigger the actuator which moves the foot platforms between the stowed configuration and active configurations. More specifically, the entity presence detection system 200 provides an activation signal which triggers the actuator which, in turn, causes the coupling position to slide relative to the guide member so as to pivotally move the lever and thus move the foot platforms from the stowed configuration to the active configuration. This process of outwardly folding the foot platforms 165 from the stowed configuration to the active configuration is depicted by FIGS. 5-6.

It will therefore be understood that, in this embodiment, the proximity sensors 210 in the lifting handle 180 may be used to initiate the activating system and move the casing from the closed configuration to the open configuration, and to subsequently initiate the actuator to move the foot platforms 165 from the stowed configuration to the active configuration. Thus, when a user holds the unicycle 100 by the handle, the proximity sensors 210 trigger the activating system and then the actuator. In response to this trigger, the activating system moves the casing to the open configuration (depicted in FIGS. 4 & 5) so that the lowermost portion of the wheel is exposed and can be brought into contact with a ground surface, and then the actuator moves the foot platforms 165 the open configuration (depicted in FIGS. 6 & 7) so that they project outwardly from the side of the wheel to provide support surfaces for the feet of a user. In other words, when lifted by the lifting handle 180, the unicycle may be arranged in an open and active configuration ready for deployment (e.g. placement on a ground surface).

When the user no longer desires to use the unicycle, the user grips the lifting handle to lift the unicycle from the ground. This results in the proximity sensors 210 triggering the actuator once again which then causes the foot platforms to move from the active configuration (shown in FIGS. 6 & 7) to the stowed configuration (shown in FIGS. 4 & 5), and then subsequently causes the activating system to move the casing from the open configuration (depicted in FIGS. 4 & 5) to the closed configuration (depicted in FIG. 1).

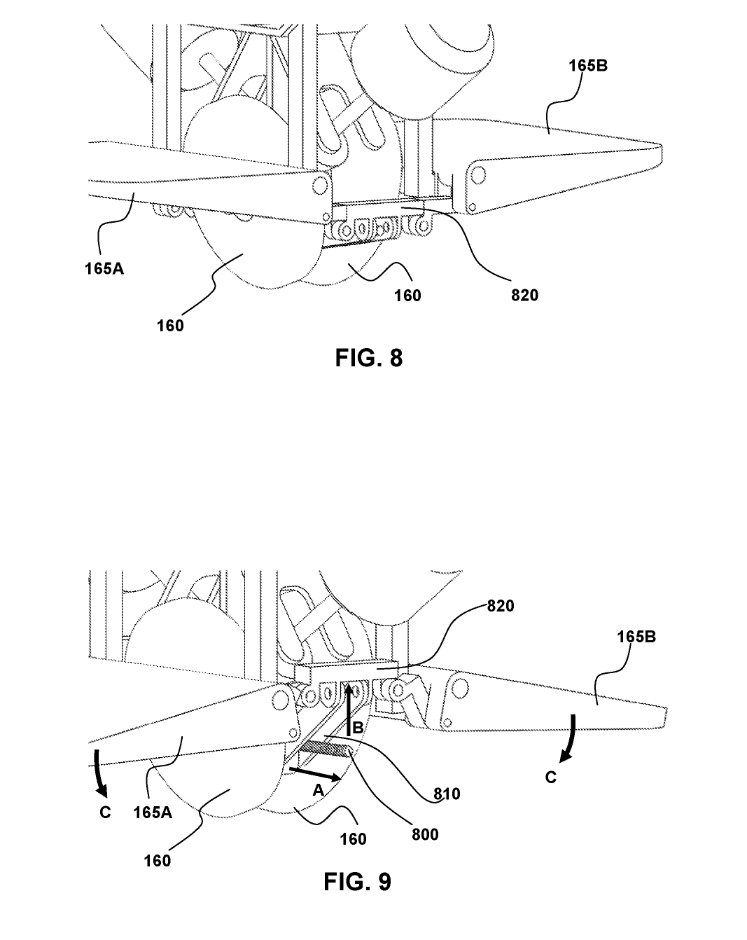

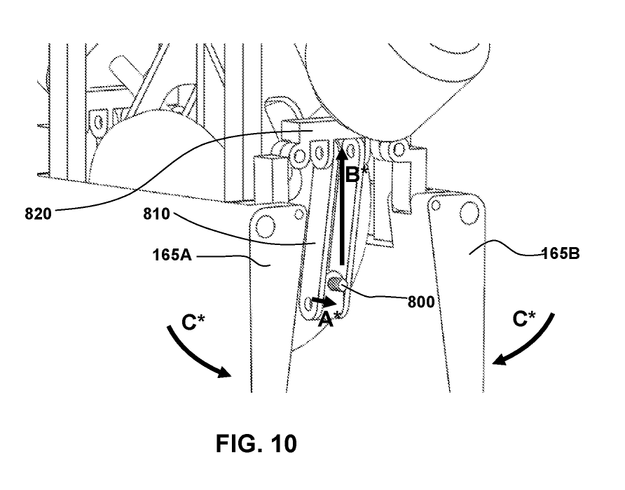

Turning now to FIGS. 8-10, there is depicted an actuator according to an embodiment of the invention. The actuator is coupled to left and right foot platform 165 and adapted to move the foot platforms 165 between an active position (depicted in FIG. 8) and a stowed position (depicted in FIG. 10).

The actuator comprises: a guide member 800; and a lever 810 pivotally connected to the foot platforms 165 and slidably coupled to the guide member 800 at a coupling position. The coupling position is adapted to be movable relative to the guide member 800 as the foot platforms are moved between the active position and stowed position.

Here, the lever 810 comprises a rigid bar of fixed length pivotally coupled to a bridging bar 820 that is pivotally coupled to the foot platforms 165.

The left foot platform 165A is pivotally coupled to one end of the bridging bar 820 and the right foot platform 165B is pivotally coupled to the other end of the bridging bar 820.

The actuator is adapted to affect sliding of the coupling position relative to the guide member 800 so as to pivotally move the lever 810. To do this, the actuator further comprises an electric motor (not visible) which is adapted to slidably move the coupling position by rotating the guide member 800 relative to the to the lever 810.

More specifically, in this embodiment, the guide member 800 is an elongate threaded member (similar to a bolt). One end of the lever 810 is threadably engaged with (e.g. screwed onto) the thread of the guide member 800 at the coupling position. By rotating the guide member (and thus its thread) relative to the lever 810, the coupling position slidably moves along the longitudinal axis of the guide member (as depicted by arrow “A” in FIG. 9). Since movement of the bridging bar 820 is generally restricted to the vertical plane, and the lever 810 is rigid bar of fixed length pivotally coupled to the bridging bar 820, the movement of the coupling position causes the other end (i.e. the end of the lever 810 pivotally coupled to the bridging bar 820) to be forced upwards (i.e. in the vertical direction) as depicted by arrow “B” in FIG. 9). This, in turn, causes inwardly folding movement of the foot platforms 165 as depicted by arrows “C” in FIG. 9.

Rotation of the guide member (and thus its thread) relative to the lever 810 may be continued until the coupling position slidably moves along the longitudinal axis of the guide member to near the end of the guide member (as depicted by arrow “A*”0 in FIG. 10). By this time, the movement of the coupling position has resulted in the end of the lever 810 that is pivotally coupled to the bridging bar 820 to be moved upwards to such an extent that the longitudinal axis of the lever is near vertical (as depicted by arrow “B*” in FIG. 10). The corresponding movement of the foot platforms 165 caused by such vertical movement of the bridging bar 820 coupled to the end of the lever 810 has then resulted in the foot platforms 165 being rotated downward (e.g. Inwardly folded as depicted by arrows “C*” in FIG. 10) to such an extent that they are in the stowed position (e.g. project downwardly such that their foot supporting surfaces are positioned substantially vertically).

Reversing the direction by which the coupling position slidably moves along the threaded guide member 800 (e.g. by reversing the direction by which the motor rotates the guide member 800) will result in the reversing the movement of the lever, the bridging member and foot platforms. In other words, by rotating the guide member (and thus its thread) relative to the lever 810 in the opposite direction, so that the coupling position slidably moves along the longitudinal axis of the guide member in the opposite direction to that depicted by arrows “A” and “A*”, the lever can be pulled downwards (in the opposite direction to that depicted by arrows “B” and “B*”) to lower the bridging bar 820 and, in turn, cause upward rotation (e.g. outwardly folding movement in the opposite direction to that depicted by arrows “C” and “C*”) of the foot platforms. In this way, the actuator causes movement of the foot platforms from the stowed position to the active position.

The embodiment of FIGS. 8-10 may therefore be employed in a self-balancing powered unicycle device to enable rapid enablement/disablement of the unicycle by being adapted to move the foot platform between an active configuration and a stowed configuration. This may be done automatically when a user dismounts from, or carries, the unicycle for example. Such automatic stowage of the foot platform may improve user experience by assisting in space spacing and/or storage of the device when a user steps off the device, for example. It may also improve device safety by altering the position of the foot platforms if a user dismounts or falls from the unicycle, for example.

It will be appreciated that variations on actuator arrangements described above may employ other arrangement and/or mechanism for slidably coupling the lever to guide member. For example, in another embodiment, the lever may be slidably coupled to the guide member via a slide mechanism. The slide mechanism may comprise: a track provided on the guide member; and a follower provided on the lever to move along the track as the foot platform is moved between the stowed position and active position. By way of example the follower may comprise at least one wheel pivotally connected to the lever, and rotation of the at least one wheel may be driven by a motor. In other words, a motor may be arranged to drive a wheel along a track provided on the guide member so as to cause movement of the lever, and thereby move the foot platform(s).

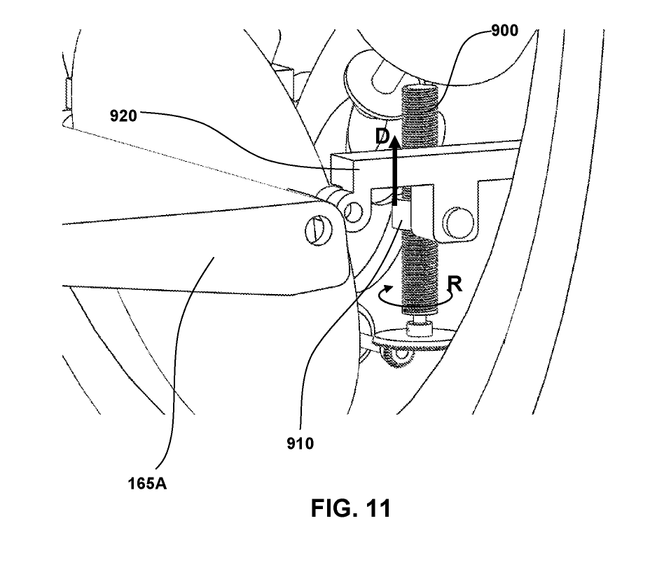

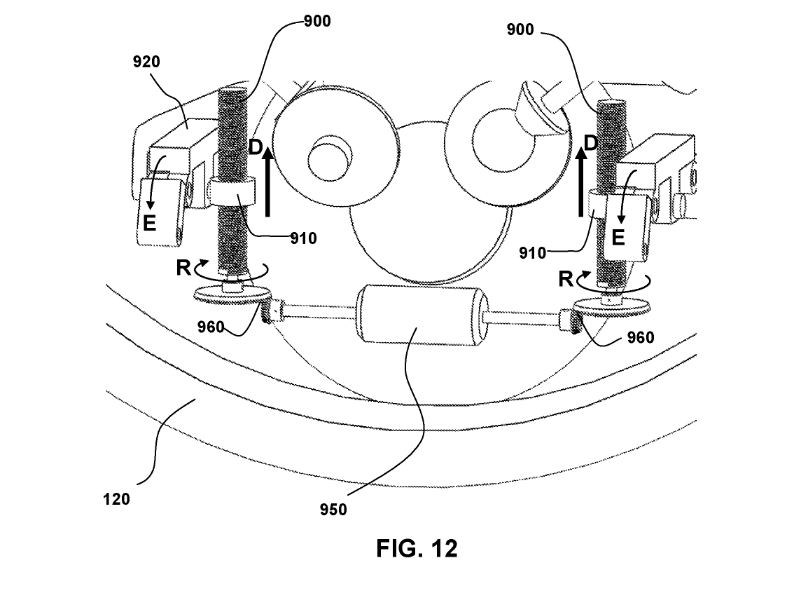

Turning now to FIGS. 11-12, there is depicted an actuator according to another embodiment of the invention. The actuator is coupled to left and right foot platform 165 and adapted to move the foot platforms 165 between an active position (depicted in FIG. 11) and a stowed position.

The actuator comprises: a guide member 900; and a connecting element 910 connected to the foot platforms 165 and slidably coupled to the guide member 900 at a coupling position. The coupling position is adapted to be movable relative to the guide member 900 as the foot platforms are moved between the active position and stowed position.

Here, the connecting element 910 comprises a threaded nut or sleeve 910 threadably engaged with a threaded section of the guide member 900 at the coupling position. The connecting element is coupled to a bridging bar 920 that is pivotally coupled to the foot platforms 165.

The left foot platform 165A is pivotally coupled to one end of the bridging bar 920 and the right foot platform 165B is pivotally coupled to the other end of the bridging bar 920.

The actuator is adapted to affect sliding of the coupling position relative to the guide member 900 so as to move the threaded nut or sleeve 910 up or down along the vertically oriented threaded section of the guide member 900. To do this, the actuator further comprises an electric motor 950 and gear arrangement 960 which is adapted to slidably move the coupling position by rotating the guide member 900 relative to the to the threaded nut or sleeve 910, as indicated by the arrow labeled R in FIGS. 11 and 12.

More specifically, in this embodiment, the guide member 900 is an elongate threaded member (similar to a threaded bolt). The threaded nut 910 is threadably engaged with (e.g. screwed onto) the thread of the guide member 900 at the coupling position. By rotating the guide member (and thus its thread) relative to the nut 910, the coupling position slidably moves along the longitudinal axis of the guide member (as depicted by arrow “D” in FIG. 11 for example). Since movement of the bridging bar 920 is generally restricted to the vertical plane, the movement of the coupling position causes the bridging bar 920 to be forced upwards (i.e. in the vertical direction) as depicted by arrow “D” in FIG. 11). This, in turn, causes inwardly folding movement of the foot platforms 165 as depicted by arrow “E” in FIGS. 11 and 12.

Rotation of the guide member 900 (and thus its thread) relative to the connecting element 910 may be continued until the coupling position slidably moves along the longitudinal axis of the guide member to near the end of the guide member. By this time, the movement of the coupling position has resulted in the bridging bar 920 being moved upwards to such an extent that the movement of the foot platforms 165 caused by such vertical movement of the bridging bar 920 has then resulted in the foot platforms 165 being rotated downward (e.g. inwardly folded as depicted by arrows “E”) to such an extent that they are in the stowed position (e.g. project downwardly such that their foot supporting surfaces are positioned substantially vertically).

Reversing the direction by which the coupling position slidably moves along the threaded guide member 900 (e.g. by reversing the direction by which the motor rotates the guide member 900) will result in the reversing the movement of the connecting element 910, the bridging member 920 and foot platforms. In other words, by rotating the guide member 900 (and thus its thread) relative to the nut 910 in the opposite direction, so that the coupling position slidably moves downwards along the vertical longitudinal axis of the guide member (in the opposite direction to that depicted by arrows “D”), the bridging bar 920 is lowered which, in turn, causes upward rotation (e.g. outwardly folding movement in the opposite direction to that depicted by arrows “E”) of the foot platforms. In this way, the actuator causes movement of the foot platforms from the stowed position to the active position.

The embodiment of FIGS. 11-12 may therefore be employed in a self-balancing powered unicycle device to enable rapid enablement/disablement of the unicycle by being adapted to move the foot platform between an active configuration and a stowed configuration. This may be done automatically when a user dismounts from, or carries, the unicycle for example. Such automatic stowage of the foot platform may improve user experience by assisting in space spacing and/or storage of the device when a user steps off the device, for example. It may also improve device safety by altering the position of the foot platforms if a user dismounts or falls from the unicycle, for example.

It is also noted that the embodiments described above include two (e.g. left and right) foot platforms. It is to be understood that proposed embodiments need not be restricted to being employed to move two foot platforms, but may instead be employed to move only a single foot platform (that is connected to the lever for example). Indeed, self-balancing powered unicycles having a single foot platform that extends through the unicycle so as to project from either side are already available, and by way of example, the lever may be pivotally connected to the single foot platform so that vertical movement of the lever is accompanied by rotation of single foot platform between two positions.

Accordingly, while specific embodiments have been described herein for purposes of illustration, various modifications will be apparent to a person skilled in the art and may be made without departing from the scope of the invention.

For example, although embodiments have been described as employing single concepts or components for detecting the presence of a user on, or at part of, a unicycle, it should be understood that embodiment may employ one or more combinations of such concepts or components. A proximity sensor may therefore be employed in conjunction with a vibration sensor, and the signal provided by these sensors may be used in isolation (for altering unicycle operation in different ways for example), or may be used together (for confirming a signal from one of the sensors for example).

Also, the actuator may comprise any suitable arrangement for affecting or driving movement of the coupling position along the guide member. For example, embodiments may comprise one or more hydraulic, electric or mechanical actuators adapted to slidably move the coupling position along the guide member.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A self-balancing powered unicycle device, comprising:
a single wheel;
a motor configured to drive the single wheel;
a balance control system configured to maintain fore-aft balance of the unicycle device;
a foot platform for supporting a user of the unicycle device, wherein the foot platform is movable between a stowed position and an active position; and
an actuator coupled to the foot platform and adapted configured to move the foot platform between the stowed position and the active position,
wherein the actuator comprises: a guide member; and a connecting element connected to the foot platform and coupled to the guide member at a coupling position.

2. The unicycle device of claim 1, wherein the connecting element is coupled to a bridging bar that is pivotally coupled to the foot platform.

3. The unicycle device of claim 2, wherein the foot platform comprises left and right foot supporting sections situated on opposite sides of the single wheel, and wherein the left foot supporting section is pivotally coupled to a first end of the bridging bar and the right foot supporting section is pivotally coupled to a second end of the bridging bar that opposes the first end.

4. The unicycle device of claim 1, wherein the actuator further comprises:
at least one hydraulic, electric or mechanical actuating element configured to move the coupling position.

5. The unicycle device of claim 1, wherein the connecting element comprises a lever pivotally connected to the foot platform and coupled to the guide member at the coupling position.

6. The unicycle device of claim 5, wherein the lever comprises a rigid bar of fixed length.

7. The unicycle device of claim 5, wherein the actuator is configured to affect movement of the coupling position relative to the guide member so as to pivotally move the lever.

8. The unicycle device of claim 5, wherein the lever is threadably engaged with a threaded section of the guide member at the coupling position, and
wherein the actuator comprises an electric motor configured to cause rotation of the threaded section relative to the lever so as to slidably move the coupling position and thereby cause movement of the foot platform between the stowed position and the active position.

9. The unicycle device of claim 5, wherein the lever is slidably coupled to the guide member via a slide mechanism, the slide mechanism comprising:
a track provided on the guide member; and
a follower provided on the lever to move along the track as the foot platform is moved between the stowed position and the active position.

10. The unicycle device of claim 9, wherein the follower comprises at least one follower wheel pivotally connected to the lever.

11. The unicycle device of claim 1, wherein the connecting element comprises a threaded nut or sleeve threadably engaged with a threaded section of the guide member at the coupling position, and
wherein the actuator comprises an electric motor configured to cause rotation of the threaded section relative to the connecting element so as to slidably move the coupling position and thereby cause movement of the foot platform between the stowed position and the active position.

12. The unicycle device of claim 1, further comprising:
an entity presence detection system configured to detect the presence of an entity on, at, or near a part of the unicycle device and provide an indication of detected entity presence; and
a control system configured to control operation of the actuator based on the indication of detected entity presence provided by the entity presence detection system.

13. The unicycle device of claim 12, wherein the entity presence detection system comprises at least one of:
at least one proximity sensor configured to detect the existence of an entity in close proximity with the at least one proximity sensor;
a vibration sensor configured to detect a frequency and/or amplitude of vibration of at least one part of the unicycle device; or
a load sensing system configured to determine a loading applied to at least one part of the unicycle device.

14. An actuator for a self-balancing powered unicycle device having a foot platform for supporting a user of the unicycle device, the foot platform being movable between a stowed position and an active position, the actuator being configured to move the foot platform between the stowed position and the active position, and wherein the actuator comprises:
a guide member; and
a connecting element configured to be connected to the foot platform and coupled to the guide member at a coupling position.

15. The actuator of claim 14, wherein the connecting element is coupled to a bridging bar that is pivotally coupled to the foot platform.

16. The actuator of claim 15, wherein the foot platform comprises left and right foot supporting sections situated on opposite sides of a single wheel of the unicycle device, and wherein a first end of the bridging bar is configured to be pivotally coupled to the left foot supporting section and wherein a second end of the bridging bar is configured to be pivotally coupled to the right foot supporting section.

17. The actuator of claim 14, wherein the actuator further comprises:
at least one hydraulic, electric or mechanical actuating element configured to move the coupling position.

18. The actuator of claim 14, wherein the connecting element comprises a lever pivotally connected to the foot platform and coupled to the guide member at the coupling position.

19. The actuator of claim 18, wherein the lever comprises a rigid bar of fixed length.

20. The actuator of claim 18, wherein the actuator is configured to affect movement of the coupling position relative to the guide member so as to pivotally move the lever.

21. The actuator of claim 18, wherein the guide member comprises a threaded section,
wherein the lever is threadably engaged with the threaded section of the guide member at the coupling position, and
wherein the actuator comprises an electric motor configured to cause rotation of the threaded section relative to the lever so as to slidably move the coupling position and thereby cause movement of the foot platform between the stowed position and the active position.

22. The actuator of claim 14, wherein the guide member comprises a threaded section,
wherein the connecting element comprises a threaded nut or sleeve threadably engaged with the threaded section of the guide member at the coupling position, and
wherein the actuator comprises an electric motor configured to cause rotation of the threaded section relative to the connecting element so as to slidably move the coupling position and thereby cause movement of the foot platform between the stowed position and the active position.

23. (canceled)

24. (canceled)
